(19) United States
(12) Patent Application Publication
(10) Pub. No.: US 2026/0329081 A1
(43) Pub. Date: Oct. 22, 2026

(54) DISPLAY DEVICE WITH DIFFUSER

(71) Applicant: Continental Automotive Technologies GmbH, Hannover (DE)

(72) Inventors: Christian Junge, Frankfurt am Main (DE); Andreas Kolloch, Mainz (DE)

(73) Assignee: Continental Automotive Technologies GmbH, Hannover (DE)

(21) Appl. No.: 19/113,286

(22) PCT Filed: Sep. 22, 2023
(86) PCT No.: PCT/DE2023/200197

§ 371 Date: Mar. 19, 2025

(30) Foreign Application Priority Data
Sep. 30, 2022 (DE) 10 2022 210 445.5

(51) Int. Cl. G02B 27/01; G02B 3/00; G02B 5/02; G02B 27/30

(52) U.S. Cl. CPC G02B 27/0101; G02B 3/0043; G02B 5/0221; G02B 27/30

(57) ABSTRACT

The present disclosure relates to a display device having an illumination unit, a diffuser and a display panel. The diffuser comprises a microlens array having a plurality of microlenses. In this context, the geometry of the microlenses varies across the surface of the microlens array in such a way that the microlens array has a diffuser function and a superordinate lens function.

### CROSS REFERENCE TO RELATED APPLICATIONS

This US patent application claims the benefit of PCT patent application No. PCT/DE 2023/200197, filed Sep. 22, 2023, which claims the benefit of German patent application No. 10 2022 210 445.5, filed Sep. 30, 2022, all of which are hereby incorporated by reference.

### TECHNICAL FIELD

The present disclosure relates to a display device having an illumination unit, a diffuser and a display panel.

### BACKGROUND

Microlens arrays are used as optical elements in a variety of applications. When used, the microlenses are usually arranged in a regular grid and follow the same lens geometry at each position of the grid. Should a structured light beam pass through such a microlens array, a customized light distribution similar to that of a diffuser film may be generated by way of the geometry of the microlens surface.

For example, DE 196 30 736 B4 describes a projection screen for a rear-projection television set, comprising a Fresnel lens with circular divisions for focusing incident image light onto the center of the optical axis of the projection screen, and an optical diffuser part with a lenticular screen portion for rendering the image light received from the Fresnel lens diffuse.

US 2018/0 149 860 A1 describes an optical scanning control device. The optical scanning control device includes a scanning unit configured to scan light emitted from a laser and a screen on which the light scanned by the scanning unit forms an image. A plurality of microlenses are arranged in an array on a surface of at least one of a light-entering side and a light-exiting side of the screen. The microlenses are arranged in such a way in this case that the center-to-center distances are randomized in at least one of a first direction and a second direction orthogonal to the first direction.

In head-up displays, a global lens function is often also required in addition to the diffuser property. This is usually realized by way of a lens on an additional face. In this context, the lens may be embodied as a thick lens or else as a Fresnel lens. However, a challenge posed by this approach lies in the fact that not every system has a corresponding number of faces available, and additional components with corresponding additional costs and efficiency losses must then be introduced.

Another approach lies in combining a microlens array with a thick lens by virtue of the structure of the microlens array being arranged on a thick lens and following the surface curvature of the lens. However, manufacturing a thick lens is complex, and this is associated with increased costs.

US 2012/0 262 646 A1 describes a film that also has diffusion properties in addition to polarization selectivity. The film may comprise a plurality of microlenses. The film may find use in a display apparatus.

WO 2019/238 842 A1 describes an apparatus for generating a virtual image with scanning image creation. The apparatus comprises at least one light source for producing a light beam, an image-generating unit for producing an image, and an optical waveguide for expanding an exit pupil. An optical component for implementing a field point-dependent aperture is arranged upstream of an input coupling region of the optical waveguide. The optical component may have a locally resolved diffuser and lens function.

JP 2021-135 472 A describes a display apparatus having a light source, a scanner that deflects the light emitted by the light source, and an optical element having a plurality of microoptical elements arranged in an array. The optical element scatters the incident light by means of the microoptical elements. The propagation direction of the scattered light varies according to the angle of incidence of the light that comes from the scanner and is incident on the optical element.

### SUMMARY

A problem addressed by the invention is that of providing an alternative solution for a display device with a diffuser, in which the diffuser has not only the diffuser property but also a lens function.

This problem is solved by a display device having the features of claim 1. Preferred embodiments of the disclosure are the subject matter of the dependent claims.

According to one aspect of the disclosure, a display device comprises an illumination unit, a diffuser and a display panel. The diffuser comprises a microlens array having a plurality of microlenses. In this context, the microlenses are sections of a lens, and the geometry of the microlenses varies across the surface of the microlens array in such a way that the microlens array has a diffuser function and a superordinate lens function by virtue of the respective position of the section in relation to a center of the lens varying across the surface of the microlens array.

In the solution according to the disclosure, use is made of a diffuser that combines a diffuser function and a global lens function on a preferably flat surface. The basis of this diffuser is formed by a microlens array having a plurality of microlenses. The desired expansion of the light distribution is generated for incident light by way of the selection of the geometry of the microlenses. The global lens function is achieved by virtue of the geometry of the microlenses varying locally, i.e. depending on the position of the respective microlens in the microlens array. Since two functions are combined in one component, the display device is optimized in terms of complexity and cost. Almost any desired global lens may be produced by way of a suitable selection of the geometry of the individual microlenses. The concept here is that of in each case ascertaining the local, two-dimensional gradient at the center of the aperture, which is defined by the associated microlens, for any surface geometry of the global lenses and choosing the geometry of the respective microlens in accordance with the ascertained gradient. In this way, the global lens is impressed, as it were, on the light distribution of the microlens array.

According to the disclosure, the microlenses are sections of a lens, and the global lens function is achieved by varying the respective position of the section in relation to a center of the lens across the surface of the microlens array. For example, the lens may have the shape of a spherical lens. The microlenses may form sections of a lens. In this context, the respective position of the section in relation to a center of the lens varies across the surface of the microlens array. At the center of the microlens array, the section may, e.g. in a microlens, lie symmetrically around the center of the lens, e.g. the vertex, while the respective section in the microlenses is displaced relative to the center of the lens at the edge of the microlens array. As a result, light that passes through these microlenses is not only expanded according to the diffuser function but also experiences a deflection that corresponds to a global lens. Almost any desired global lens may be produced by way of an appropriate adaptation of the displacement of the sections of the individual microlenses.

According to one aspect of the disclosure, the microlenses are arranged in a regular grid. The arrangement of the microlenses in a regular grid has the advantage that the resulting light distribution may be controlled very precisely.

According to one aspect of the disclosure, the microlenses have a rectangular aperture. This should be understood to mean that the microlenses each have a rectangular base area in a plan view. This leads to the distribution of the outgoing light beams having an approximately rectangular cross section. Such a cross section is often desired, for example for illuminating the eyebox in a head-up display. In principle, however, the base areas of the microlenses may also have other shapes, for example round, hexagonal, etc.

According to one aspect of the disclosure, the microlens array has the function of a cylindrical lens. Such a cylindrical lens may be used, for example, to correct aberrations or adjust the light at the display panel provided by the illumination unit. In principle, however, other global lens functions may also be realized, e.g. spherical or aspherical converging lenses or diverging lenses.

According to one aspect of the disclosure, the display device is a constituent part of a head-up display. The use of a display device according to the disclosure for head-up displays is particularly advantageous since a global lens function, in addition to the diffuser property, is often also required in said head-up displays.

According to one aspect of the disclosure, the illumination unit provides collimated light. The solution according to the disclosure is particularly suitable for collimated light since a very precisely defined angular distribution of the input light is present in this case. Thus, the angular distribution of the output light is also determined very precisely.

According to one aspect of the disclosure, the illumination unit comprises a light source array and a collimator array. The light source array is formed by an arrangement of a plurality of light sources whose light is collimated by a plurality of collimators that form the collimator array. In this way, it is possible to realize a large-area illumination unit that ensures a homogeneous illumination of the display panel. In principle, however, the described solution may be implemented in display devices with illumination optical units of all types.

A display device according to the disclosure is preferably used in a means of transportation. The means of transportation may be, for example, a motor vehicle, but alternatively it may also be an aircraft, a rail vehicle or a watercraft.

### BRIEF DESCRIPTION OF THE DRAWINGS

Further features of the present disclosure will become apparent from the following description and the appended claims in conjunction with the figures.

FIG. 1 schematically shows a head-up display according to the prior art for a motor vehicle;

FIG. 2 schematically shows a display device of a head-up display;

FIG. 3 schematically shows a display device according to the disclosure in a head-up display;

FIG. 4 illustrates the operating principle of a diffuser with a rough surface;

FIG. 5 illustrates the operating principle of a microlens array as a diffuser;

FIG. 6 schematically shows a first region of a diffuser of a display device according to the disclosure;

FIG. 7 schematically shows a second region of a diffuser of a display device according to the disclosure;

FIG. 8 illustrates the implementation of microlenses of a microlens array as sections of a lens; and

FIG. 9 schematically shows a means of transportation that utilizes a display device according to the disclosure.

### DETAILED DESCRIPTION

For a better understanding of the principles of the present disclosure, embodiments of the disclosure are explained in more detail below with reference to the figures. Identical reference signs are used for identical or functionally identical elements in the figures and are not necessarily described again for each figure. It goes without saying that the disclosure is not restricted to the embodiments represented and that the features described may also be combined or modified without departing from the scope of protection of the disclosure as defined in the appended claims.

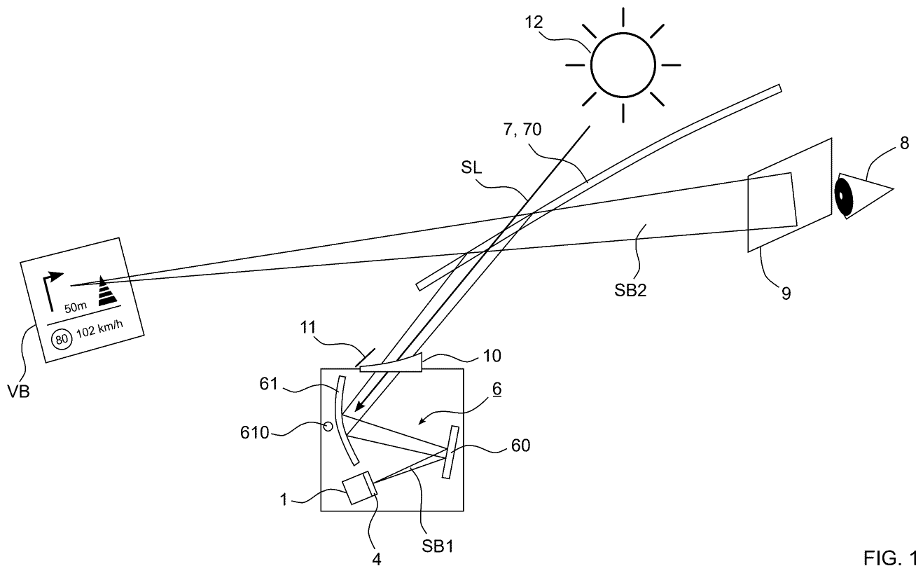

FIG. 1 shows a schematic diagram of a head-up display for a motor vehicle according to the prior art. The head-up display comprises a display device 1, an optical unit 6, and a mirror unit 7. A beam of rays SB1 emanates from a display panel 4 of the display device 1 and is reflected off a first mirror 60 onto a curved mirror 61, which reflects it in the direction of the mirror unit 7. The mirror unit 7 is represented here as a windshield 70 of a motor vehicle. From there, the beam of rays SB2 travels in the direction of an eye 8 of a viewer.

The viewer sees a virtual image VB that is located outside the motor vehicle, above the engine hood or even in front of the motor vehicle. Due to the interaction between the optical unit 6 and the mirror unit 7, the virtual image VB is an enlarged representation of the image displayed by the display panel 4. A speed limit, the current vehicle speed and navigation instructions are symbolically represented here. As long as the eye 8 is within the eyebox 9, which is indicated by a rectangle, all elements of the virtual image VB are visible to the eye 8. If the eye 8 is outside the eyebox 9, the virtual image VB is visible only partially or not at all to the viewer. The larger the eyebox 9, the less restricted the viewer is when choosing their seating position.

The curvature of the curved mirror 61 is adapted to the curvature of the windshield 70 and ensures that the image distortion is stable over the entire eyebox 9. The curved mirror 61 is rotatably mounted by means of a mounting 610. The rotation of the curved mirror 61 that this allows thereby makes it possible to displace the eyebox 9 and thus to adapt the position of the eyebox 9 to the position of the eye 8. The first mirror 60 serves to ensure that the path traveled by the beam of rays SB1 between the display panel 4 and the curved mirror 60 is long and, at the same time, that the optical unit 6 is nevertheless compact. The optical unit 6 is delimited from the environment by a transparent cover 10. The optical elements of the optical unit 6 are thus protected, for example against dust located in the interior of the vehicle. Anti-glare protection 11 serves to reliably absorb the light reflected via the interface of the cover 10 so that the observer is not dazzled. In addition to the sunlight SL, the light from another stray light source 12 may also reach the display panel 4.

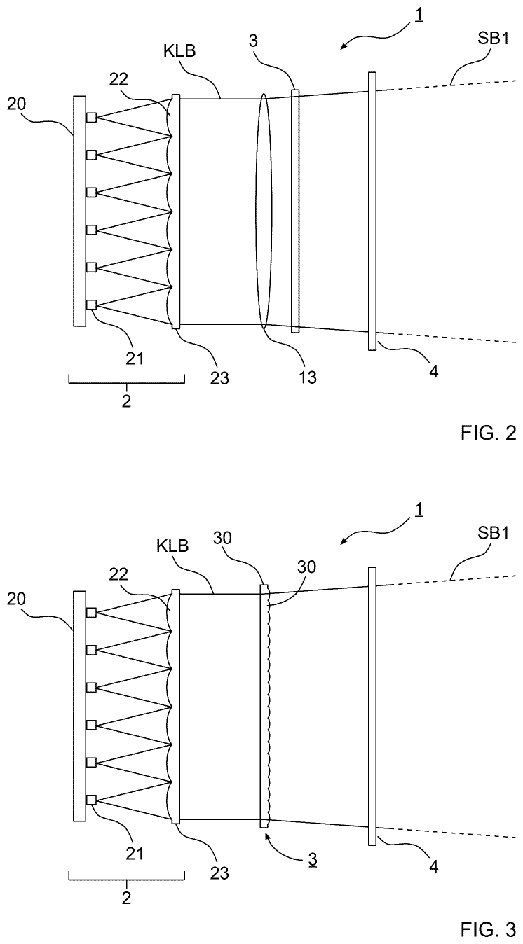

FIG. 2 schematically shows a display device 1 of a head-up display. The display device 1 comprises an illumination unit 2 with a light source array 20, i.e. an arrangement of a plurality of light sources 21, the light of which is collimated by a plurality of collimators 22 that form a collimator array 23. On the path to the display panel 4, the collimated light beam KLB that emanates from the collimator array 23 passes through a lens 13 and a diffuser 3. For example, the lens may be a cylindrical Fresnel lens. The diffuser 3 may be designed as a diffuser film, for example. After passing through the display panel 4, the light beam enters the optical unit, which is not shown in FIG. 2, as a beam of rays SB1.

FIG. 3 schematically shows an example of a display device 1 according to the disclosure in a head-up display. In this case, the display device 1 also comprises an illumination unit 2 having a light source array 20 and a collimator array 23. It is self-evident that other types of light sources may also be used instead of a light source array 20. It is also sufficient for the resultant collimated light beam KLB to be only approximately collimated. On the path to the display panel 4, the collimated light beam KLB once again passes through a diffuser 3. The diffuser 3 is formed by a microlens array 30 having a plurality of microlenses 31. In this context, the geometry of the microlenses 31 varies across the surface of the microlens array 30 in such a way that the microlens array 30 also has a superordinate lens function in addition to the diffuser function. It is therefore possible to manage without an additional lens, as is required in the display device 1 shown in FIG. 2. After passing through the display panel 4, the light beam as ever enters the optical unit, which is not shown here, as a beam of rays SB1.

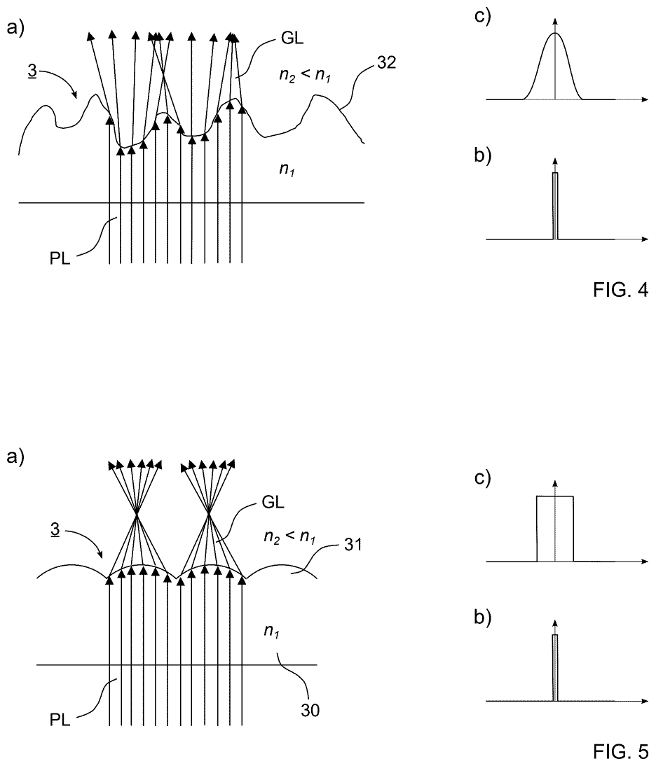

FIG. 4 illustrates the operating principle of a diffuser 3 with a rough surface 32. In this context, FIG. 4a) shows the basic course of the light beams, FIG. 4b) shows the angular distribution of the light beams prior to scattering and FIG. 4c) shows the angular distribution of the light beams post scattering. The incident light PL is approximately parallel. Its angular distribution is therefore very narrow. As a result of the refraction of the light beams on the rough surface 32 at the transition from the diffuser 3 with refractive index n1 to the surrounding medium, typically air, with refractive index n2, where n2<n1, the angular distribution is significantly widened. Due to the irregular geometry of the rough surface 32 and the associated random scattering, the angular distribution of the scattered light GL may have e.g. the form of a Gaussian curve.

FIG. 5 illustrates the operating principle of a microlens array 30 as a diffuser 3. In this context, FIG. 5a) shows the basic course of the light beams, FIG. 5b) shows the angular distribution of the light beams prior to scattering and FIG. 5c) shows the angular distribution of the light beams post scattering. The incident light PL in turn is approximately parallel. Its angular distribution is therefore very narrow. As a result of the refraction of the light beams by the microlenses 31 of the microlens array 30 at the transition from the diffuser 3 with refractive index n1 to the surrounding medium, typically air, with refractive index n2, where n2<n1, the angular distribution is significantly widened in this case too. However, due to the regular geometry of the microlenses 31, the scattering is not random, and so the angular distribution of the scattered light GL may have a flat-top profile, for example.

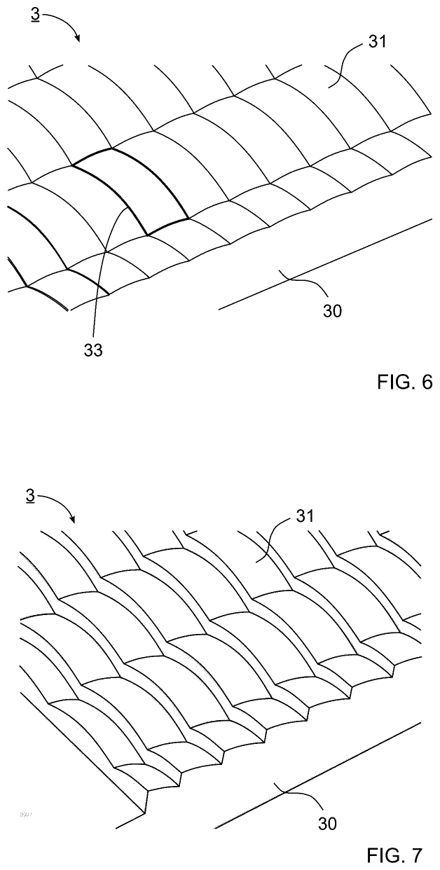

FIG. 6 schematically shows a first region of a diffuser 3 of a display device according to the disclosure. The microlenses 31 of the microlens array 30 are visible in the center of the diffuser 3. FIG. 7 schematically shows a second, near-edge region of the diffuser 3. In this example, the microlenses 31 are arranged in a regular grid and each have a rectangular aperture 33, i.e. the microlenses 31 each have the shape of a rectangle in a top view. The global lens function is achieved by virtue of the geometry of the microlenses 31 varying across the surface of the microlens array 30. The microlenses 31 form sections of a lens. In this context, the respective position of the section in relation to a center of the lens varies across the surface of the microlens array 30. At the center of the microlens array 30, the section may, e.g. in a microlens 31, lie symmetrically around the center of the lens, e.g. the vertex, while the respective section in the microlenses 31 is displaced relative to the center of the lens at the edge of the microlens array 30. As a result, light that passes through these microlenses 31 is not only expanded according to the diffuser function but also experiences a deflection that corresponds to a global lens. Almost any desired global lens can be produced by way of an appropriate adaptation of the displacement of the sections of the individual microlenses.

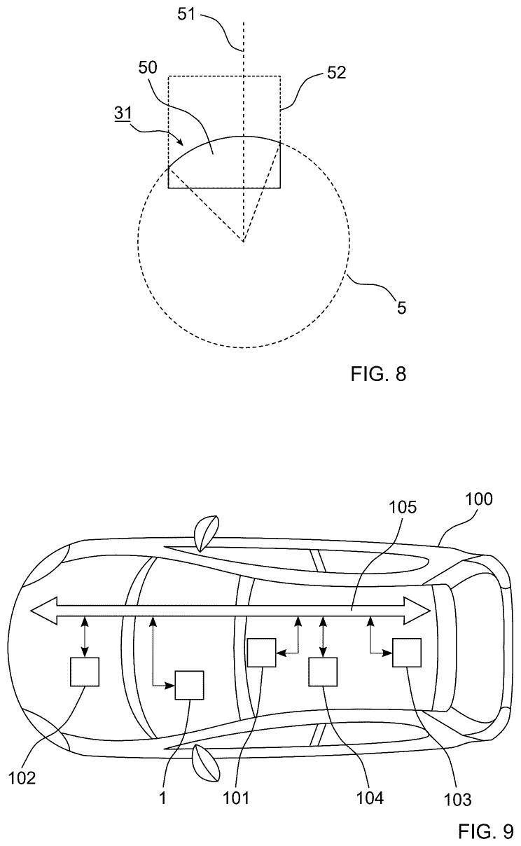

FIG. 8 illustrates the implementation of microlenses 31 of a microlens array as sections 50 of a lens 5. The lens 5 is a spherical lens in the example shown. For the sake of simplicity, only a two-dimensional view is shown. The lens 5 has a center 51, e.g. the vertex of the lens 5. The section 50 of the lens 5 that forms the microlens 31 is determined by an aperture cuboid 52 which reflects the aperture of the microlens 31. In other words, the geometry of the microlens 31 is determined by the overlap between the lens 5 and the aperture cuboid 52. The position of the aperture cuboid 52 relative to the center 51 of the lens 5 depends on the position of the respective microlens 31 in the microlens array.

FIG. 9 schematically shows a means of transportation 100 that utilizes a display device 1 according to the disclosure. The means of transportation 100 is a motor vehicle in this example. The motor vehicle comprises a display device 1 according to the invention, which in this example is a constituent part of a head-up display. Data relating to the vehicle surround may be acquired by way of a sensor system 101. The sensor system 101 may comprise, in particular, surround sensors, for example ultrasonic sensors, laser scanners, radar sensors, lidar sensors, or cameras. The information acquired by the sensor system 101 may be used to generate content to be displayed by the display device 1. Further constituent parts of the motor vehicle in this example are a navigation system 102, which may be used to provide position information, and also a data transmission unit 103. For example, a connection to a backend, for example for receiving updated software for components of the motor vehicle, may be established by means of the data transmission unit 103. A memory 104 is present for storing data. Data is exchanged between the various components of the motor vehicle via a network 105.

1. A display device, the display device comprising:
an illumination unit;
a diffuser; and
a display panel wherein the diffuser comprises a microlens array having a plurality of microlenses and wherein the microlenses are sections of a lens and the geometry of the microlenses varies across the surface of the microlens array in such a way that the microlens array has a diffuser function and a superordinate lens function by virtue of the respective position of the section in relation to a center of the lens varying across the surface of the microlens array.

2. The display device as claimed in claim 1, wherein the lens a spherical lens.

3. The display device as claimed in claim 1, wherein the microlenses are arranged in a regular grid.

4. The display device as claimed in claim 1, wherein the microlenses have a rectangular aperture.

5. The display device as claimed in claim 1, wherein the microlens array has the function of a cylindrical lens.

6. The display device as claimed in claim 1, wherein the display device is a constituent part of a head-up display.

7. The display device as claimed in claim 1, wherein the illumination unit provides collimated light.

8. The display device as claimed in claim 7, wherein the illumination unit comprises a light source array and a collimator array.

9. A having vehicle, the vehicle comprising:
a display-apparatus device comprising:
an illumination unit;
a diffuser; and
a display panel, wherein the diffuser comprises a microlens array having a plurality of microlenses, and wherein the microlenses are sections of a lens and the geometry of the microlenses varies across the surface of the microlens array in such a way that the microlens array has a diffuser function and a superordinate lens function by virtue of the respective position of the section in relation to a center of the lens varying across the surface of the microlens array.
